(19) United States
(12) Patent Application Publication
(10) Pub. No.: US 2004/0268410 A1
(43) Pub. Date: Dec. 30, 2004

(54) Subscription video on demand delivery

(75) Inventors: Scott G. Barton, Centennial, CO (US); Gregory R. DePrez, Highlands Ranch, CO (US); John C. Beyler, Highlands Ranch, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Starz Encore Group LLC, Englewood, CO

(21) Appl. No.: 10/863,633

(22) Filed: Jun. 7, 2004

Related U.S. Application Data
(63) Continuation-in-part of application No. 10/460,753, filed on Jun. 11, 2003.
(60) Provisional application No. 60/478,629, filed on Jun. 13, 2003.

(51) Int. Cl. H04N 7/173; H04N 7/16

(52) U.S. Cl. 725/119; 725/89; 725/134; 725/135; 725/131

(57) ABSTRACT

According to the invention, a video delivery system for on-demand videos at least partially stored proximate to a user location is disclosed. The video delivery system has a number of channels that are normally viewable within the user location and a content receiver coupled to the plurality of channels. A hidden channel of the plurality of channels transports a hidden video stream that cannot be viewed as streamed to the user location. The content receiver includes a storage device and a video rendering circuit. The storage device is coupled to the hidden channel and proximate to the user location. The storage device stores at least a portion of the hidden video stream in a non-volatile manner. The video rendering circuit is coupled to the storage device. The video rendering circuit produces a video signal representative of the portion.

This application claims the benefit of and is a non-provisional of U.S. application Serial No. 60/478,629 filed on Jun. 13, 2003, which is incorporated by reference in its entirety. Also, this application claims the benefit of and is a continuation-in-part of: U.S. patent application Ser. No. 10/460,753, filed on Jun. 11, 2003, which is also incorporated by reference in its entirety.

### BACKGROUND OF THE INVENTION

This invention relates in general to video content delivery and, more specifically, to delivering a locally-stored video.

Television broadcasters have an existing distribution plant that sends video streams down channels. Most broadcasters now provide a personal video recorder (PVR) option that allows recording of video streams. A PVR can record video streams selected by a user on viewable channels. For any authorized channel, the user can watch a video stream live or record that stream.

Content providers are starting to offer on demand subscriptions tied to a linear schedule of programs in a service called subscription video on demand (SVOD). A subscriber can watch some programs live or watch those same programs on demand. A dedicated channel to the subscriber is used to provide the on demand version of the program.

### BRIEF DESCRIPTION OF THE DRAWINGS

The present invention is described in conjunction with the appended figures:

FIG. 1A is a block diagram that shows an embodiment of a program delivery system in satellite communication with a content provider;

FIG. 1B is a block diagram that shows another embodiment of a program delivery system using satellite transmission to a group of set top boxes;

FIG. 1C is a block diagram that shows another embodiment of a program delivery system using satellite transmission to each set top box;

FIG. 1D is a block diagram that shows another embodiment of a program delivery system having user customization and programs stored in the headend;

FIG. 2A is a block diagram illustrating an embodiment of a set top box that stores programs, guide information and preferences locally;

FIG. 2B is a block diagram illustrating an embodiment of a conventional set top box;

FIG. 3A is a flow diagram that shows an embodiment of a process for pre-storing a club program local to the user using a hidden channel; and

FIG. 3B is a flow diagram that shows another embodiment of a process for pre-storing a club program local to the user using a hidden channel.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DESCRIPTION OF THE SPECIFIC EMBODIMENTS

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

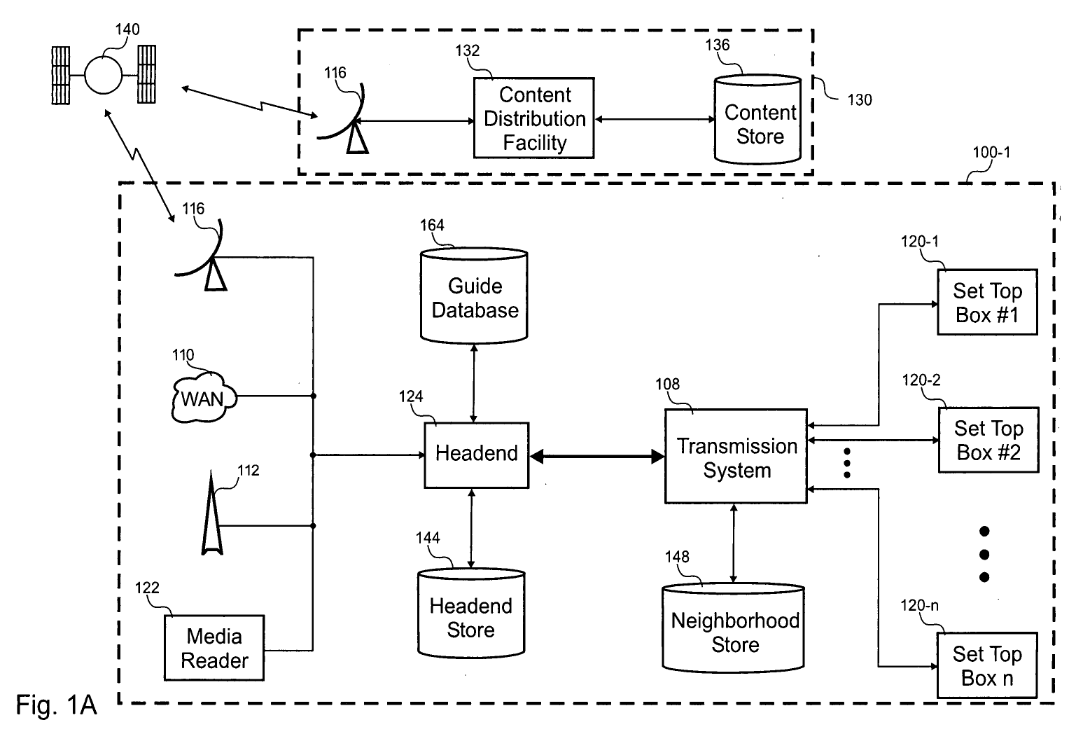

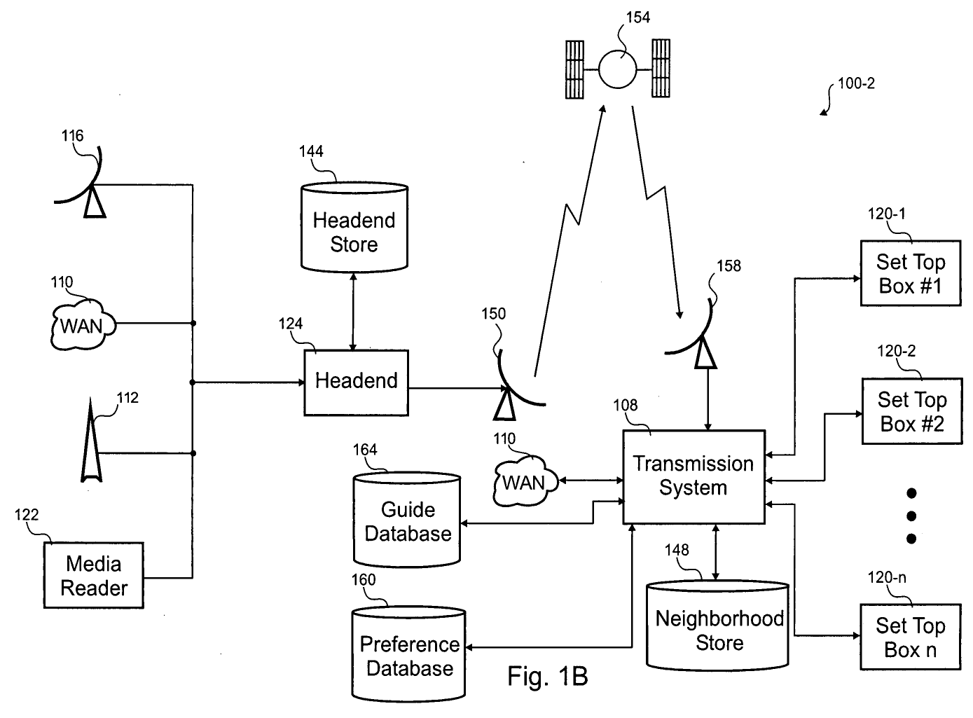

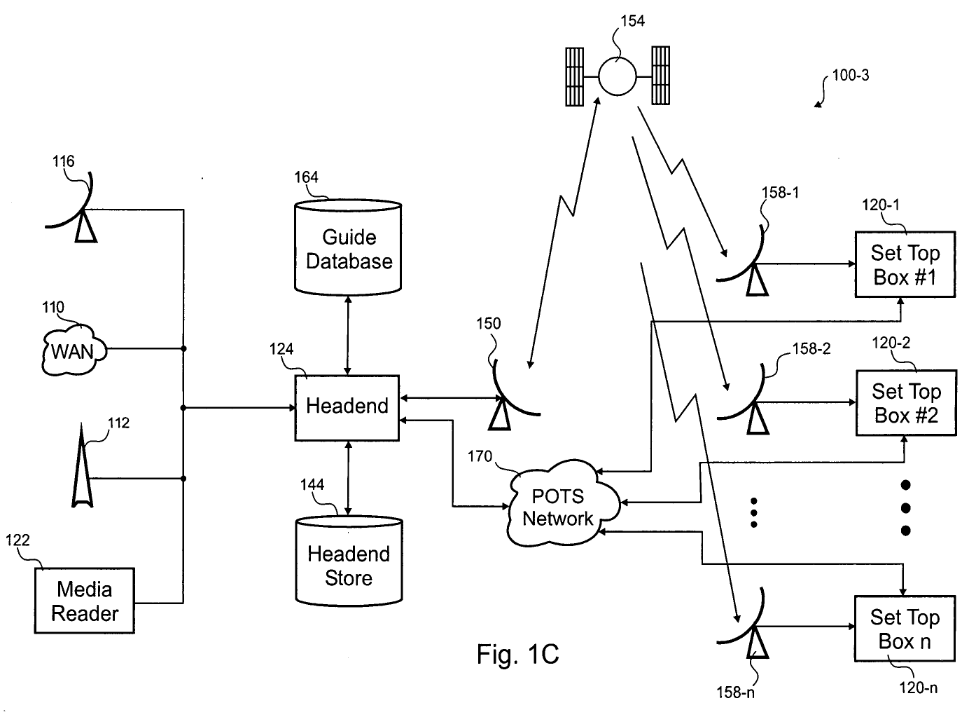

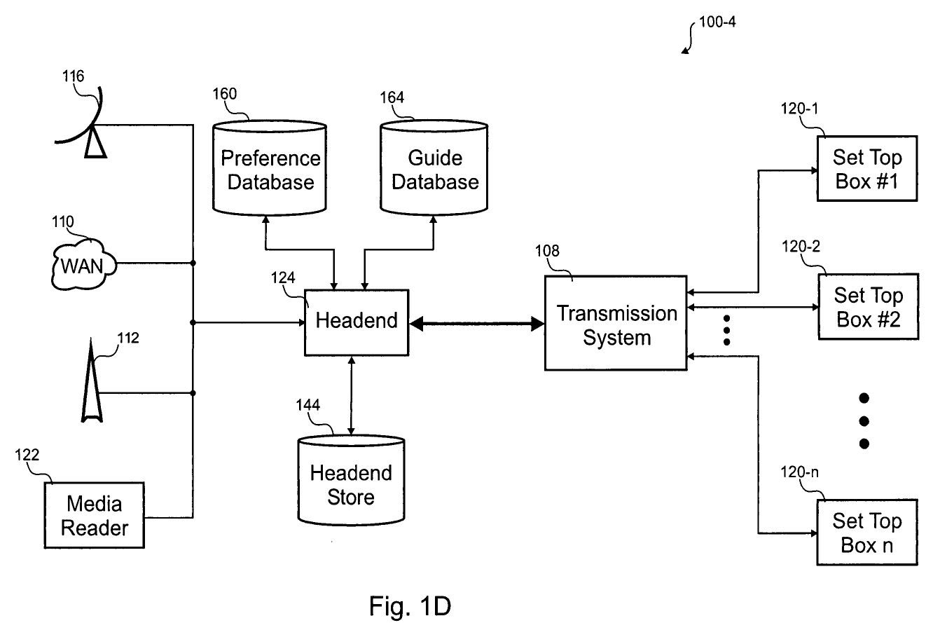

Referring first to FIG. 1A, a block diagram is shown of an embodiment of a program delivery system 100-1 in satellite communication with a content provider 130. This embodiment only depicts one content provider 130, but typically there are many content providers 130. The program delivery system 100-1 takes the content from a number of content providers 130 and delivers the content to set top boxes 120 in a broadcast or multicast fashion. The users with the set top boxes are billed by the program delivery system 100-1 in a variety of ways.

The depicted content provider 130 communicates via a satellite 140 with the program delivery system 100-1. Other embodiments could have content providers 130 that could also use a wide area network 110, a terrestrial antenna 112, a media reader 122, and/or other distribution techniques. The wide area network 110 could be a private or public network. Distribution on a public network, such as the Internet, could be protected by encryption and/or virtual private network (VPN) techniques. The terrestrial antennae 112 could accept content broadcast by local stations, sent by microwave link, or other wireless techniques. Any type of portable media could be read by various embodiments of the media reader 122. For example, a media reader could input content from magnetic tape, film, optical disk, flash drives, hard drives, magnetic disks, holographic media, etc.

This embodiment of the content provider 130 includes a satellite dish 116, a content distribution facility 132 and a content store 136. The satellite dish 116 is used to connect via the satellite 140 to another satellite dish of the program delivery system 100-1. Some embodiments could have a number of program delivery systems 100 that communicate with the content provider 130 to receive programs for geographically disparate set top boxes 120. The content store 136 is used to hold programs on tapes, optical drives, magnetic drives, and/or other storage mediums. The content distribution facility 132 retrieves, edits, formats, and transmits the content. Program guide information, program schedule, promotional audio and/or video is also forwarded by the content distribution facility 132 and stored in a guide database 164 for use in populating navigation menus.

The program delivery system 100-1 delivers the programs from various content providers 130 to the set top boxes 120 of the users. Many different topologies are used to deliver the programs. A transmission system 108 is a mix of fiber, coaxial cable, microwave datalink, and/or VDSL that is used to distribute the content to set top boxes 120. Neighborhood nodes or hubs could be included in the transmission system 108.

Some programs are relayed in real-time, while others are stored in a headend store 144 for later delivery. For example, a local network channel could be received on the terrestrial antennae 112 and coupled to the transmission system 108 for immediate delivery to the set top boxes according to a linear schedule. Some programs could be held in the headend store 144 for viewing in a linear schedule, on demand and/or as a club program. In another embodiment, programs could be distributed to a neighborhood store 148 for distribution according to a linear schedule, on demand and/or as a club program.

A number of neighborhood stores 148 could be distributed to neighborhood nodes in a larger metropolitan area such that there are sufficient singlecast channels between each neighborhood store 148 and cluster of set top boxes 120. On a singlecast channel, the user can control playback of content residing on the neighborhood store 148. The programs could be video on demand (VOD), subscription video on demand (SVOD) club programs, network-based personal video recorder (PVR) or programs from the linear schedule recorded for the user.

The guide database 164 has program descriptions, ratings, advertisements, schedule times, pricing, usage limits and promotional video and/or audio for the content available to the program delivery system 100-1. The guide database 164 could be populated by the content provider and/or a third party that gathers this type of information. Some embodiments could download relevant portions of the guide database 164 to each set top box 120 for browsing. Also, a web site could show this information in addition to making it available through the set top box 120. Programs could be selected for recording and subscriptions could be ordered through the web site. One embodiment could formulate the guide screens with information from the guide database 164 for singlecast to a particular user or set top box 120. Program information for on demand offerings are also included in the guide database 164. In some embodiments, the user allowed to watch an on demand program during a time window. The guide database 164 could store time window information. Where a particular program is available in the linear schedule and on demand, the guide database 164 could be updated such that this is reflected on the menus for users who have these two formats available.

With reference to FIG. 1B, a block diagram that shows another embodiment of a program delivery system 100-2 using satellite transmission to a group of set top boxes 120 is shown. This embodiment uses a transmission system 108 that receives content from the headend 124 by way of a satellite 154. The guide database 164 is updated through the WAN 110 and/or a satellite data channel. Some or all on demand programs reside on a neighborhood store 148. The guide database 164 is used to provide guide information screens that are singlecasted to a particular set top box 120. At the set top box 120, manipulations of the displayed information are relayed back to the neighborhood node in order to change the singlecasted menus and content stream.

The presentation of information from the set top box 120 can be customized for particular set top boxes 120, households and/or users. A preference database 160 stores customization parameters to facilitate the personalization of the set top box interface. The personalization can be per user, household or set top box 120 under the direction of the user. Information such as viewing habits, preferences, menu customizations, favorite shows, programs scheduled for recording, channel nicknames, parental controls, etc., can be stored in the preference database 160 for use by the transmission system 108. For example, the transmission system 108 can customize the menus singlecasted to a user based upon information in the preference database 160. The preference information can be passively gathered by tracking users and/or actively gathered by the user answering questions. The preference database 160 also stores information used to screen or filter which club programs are made available to a particular club member.

The transmission system 108 could communicate with the set top boxes 120 using a variety of media. Some embodiments could use ethernet, optical fiber, coaxial cable, carrier current data transport, and/or VDSL. The set top box 120 for the various media would have a port capable of interfacing to the particular media. Embodiments could use more than one media. For example, VDSL could be used to bring one or more channels to the user location, but distribution within the user location could use carrier-current networking through the power lines to other set top boxes 120 in the user location.

Referring next to FIG. 1C, a block diagram is depicted of another embodiment of a program delivery system 100-3 using satellite transmission to each set top box 120. The content is relayed by satellite 154 to a satellite receiver 158 coupled to each set top box 120. This embodiment has a return data channel through the plain old telephone system (POTS), but other embodiments could use a WAN, the Internet, a satellite uplink, a cellular data network, a wireless network, etc. Each set top box 120 in this embodiment includes a guide database 164, preference database 160 and store for programs. Some legacy set top boxes could only include a guide database.

With reference to FIG. 1D, a block diagram is depicted of another embodiment of a program delivery system 100-4 having user customization and programs stored at the headend 124 is shown. This embodiment singlecasts menu screens and at least some programs from the headend 124 to individual set top boxes 120. The specific topology could be fiber from the headend to a user location or neighborhood node. Programs are sent in a linear schedule or with VOD control. Those programs with VOD control are recorded in the headend store 144. In one embodiment, a user can specify programs from the linear schedule to be held in the headend store 144 for the benefit of that user and perhaps, other users also. In another embodiment, the user can specify filtering parameters and preferences to affect the club programs available to the user in a SVOD service. The preference database 160 and guide database 164 are maintained at the headend for the benefit of the user. Interaction by the user with the set top box 120 is relayed back to the headend such that the menus and playback is controlled.

Although some of the embodiments discuss a set top box separate from a television display, it is to be understood other embodiments could include the set top box functionality as part of another component. For example, the set top box could be integrated into the television set, digital video recorder, DVD recorder, or other audio/visual equipment. In one embodiment, the set top box functionality is on a card that can be plugged into various audio/visual equipment.

The above embodiments have differing distribution and move around the store, preference database and guide database. It is to be understood that the various embodiments could have hybrid topologies that have portions of these components in multiple disclosed locations. For example, there may be program stores proximate to the headend 124, in neighborhood nodes and in set top boxes 120. A particular user may be able to play on demand selections from any of these locations. In one embodiment, the store in the set top box 120 is only used as a last resort when the program is not available on the neighborhood node or proximate to the headend 124.

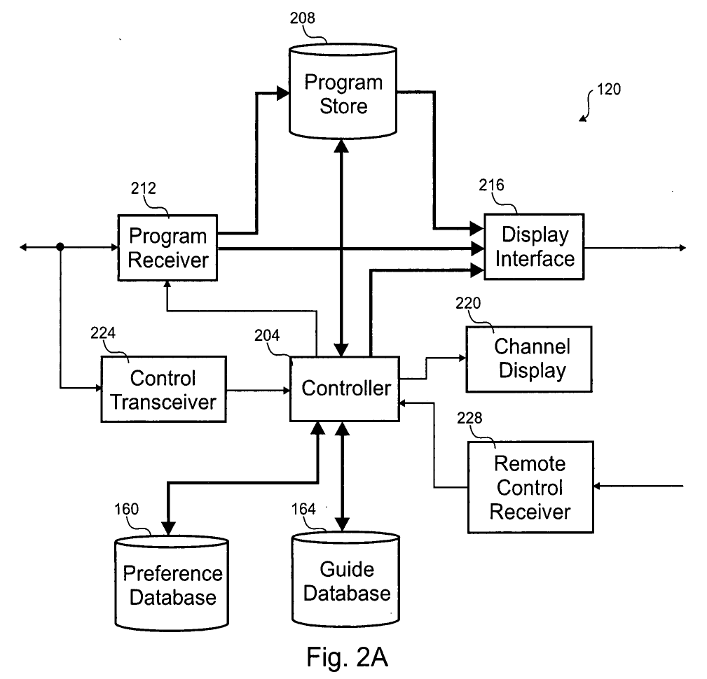

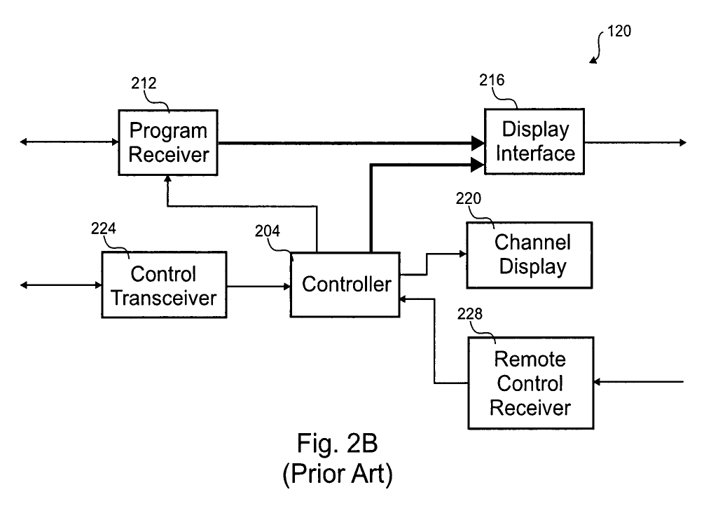

Referring next to FIG. 2A, a block diagram illustrating an embodiment of a set top box 120 that stores guide information, programs and preferences locally is shown. This embodiment receives content and control information over a common conduit, such as an optical fiber, VDSL line, and/or coaxial cable. The set top box 120 in this embodiment has a hard drive or other storage medium, such as an optical disk, flash memory, SRAM, removable disk, and/or magnetic tape. Included in the set top box 120 are a controller 204, a program store 208, a program receiver 212, a display interface 216, a channel display 220, a control transceiver 224, the preference database 160, and the guide database 164. In various embodiments, the set top box 120 could be combined with other equipment such as a television, a computer, a tuner, a home gateway, a digital music player, a personal video recorder, etc.

The program receiver 212 tunes to one or more program streams to display and/or record them. With proper authorization, the program receiver 212 can tune to hidden channels to receive club programs that are not viewable before storage. In various embodiments, the hidden channel could use a terrestrial broadcast, cable television, DBS satellite, and/or other transport format. Recordings are stored in the program store 208. Playback of live or recorded programs is done by the display interface 216, which is coupled to a monitor, plasma or LCD panel, projection system, or other display. The remote control receiver 228 receives keystrokes from a remote or other input device. Although some of the embodiments discuss the use of a remote control for activating certain functions, it is to be understood that other embodiments may include alternative methods for activating those functions. For example, voice activation, among other alternatives, may be used for such activation. The channel currently being played is shown on the channel display 220, which could also appear superimposed on the display.

The control transceiver 224 receives and sends control information. Information for the guide database 164 is received by the control transceiver 224 and could be customized by the delivery system 100 for a particular set top box 120. Information in the preference database 160 along with billing and other information is passed by the control receiver to the network node and/or headend 124. Programs could be passed through the control channel for storage in the program store 208 in addition to passing through the more typical path of the program receiver 212.

The program store 208 could be a video cassette recorder, a digital tape recorder, a hard drive, solid state storage, an optical drive, or other known storage media. The storage media could be removable or non-removable. The storage device could be external to the set top box and coupled thereto with a dedicated cable, wireless transceiver, and/or packet switched network. In some embodiments, the program store 208 could be, for example, in a residential gateway, in another computer on the network, in a network storage device, or in a storage device peripheral coupled to the set top box 120. In one embodiment, programs are received in a compressed and/or encrypted format and stored on the program store 208. As or while the program is being played the compression and/or encryption is removed.

Operation of the set top box 120 is managed by the controller 204 with use of supporting software and/or hardware. The guide database 164 and preference database 160 are used by the controller 204 to present menu screens and filter club programs for the users of the set top box 120. Some embodiments of the set top box 120 customize the user interface according to the user(s) interacting with the set top box. Biometric recognition, such as face recognition, voice recognition or keystroke recognition, could be used to determine the user. Alternative embodiments could augment or replace the automatic recognition with a screen prompt or a button on the remote. A button or switch on the remote could be assigned such that each user could indicate his or her presence. Once the identity of the viewer is known, the set top box 120 is actively or passively updates the preferences for the viewer in a multiple viewer household. Other embodiments could merely has a single set of preferences for all possible viewers and not try to resolve the particular viewer.

With reference to FIG. 2B, a block diagram illustrating an embodiment of a conventional set top box 120 is shown. This embodiment receives linear programs in the conventional manner. Any programs from the linear schedule are recorded in the neighborhood node or the headend 124 for respective storage in a neighborhood store 148 or headend store 144. Those stored programs can be singlecasted to the set top box 120 for later viewing. Similarly, the guide and preference databases 164, 160 are maintained elsewhere, but used when singlecasting the menu information to the set top box 120 for display.

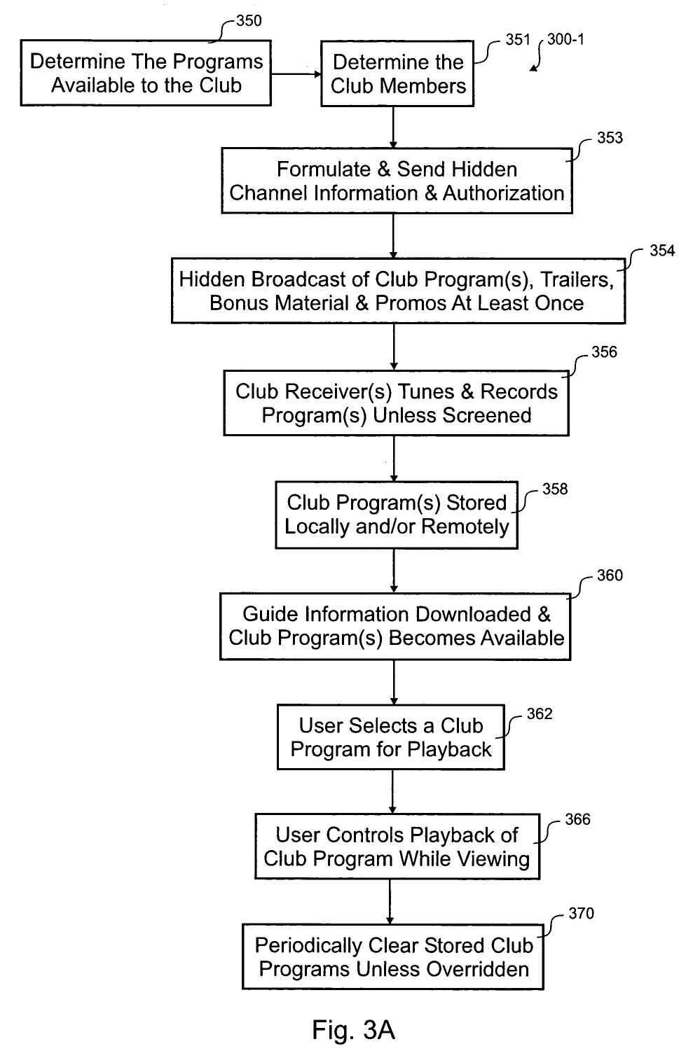

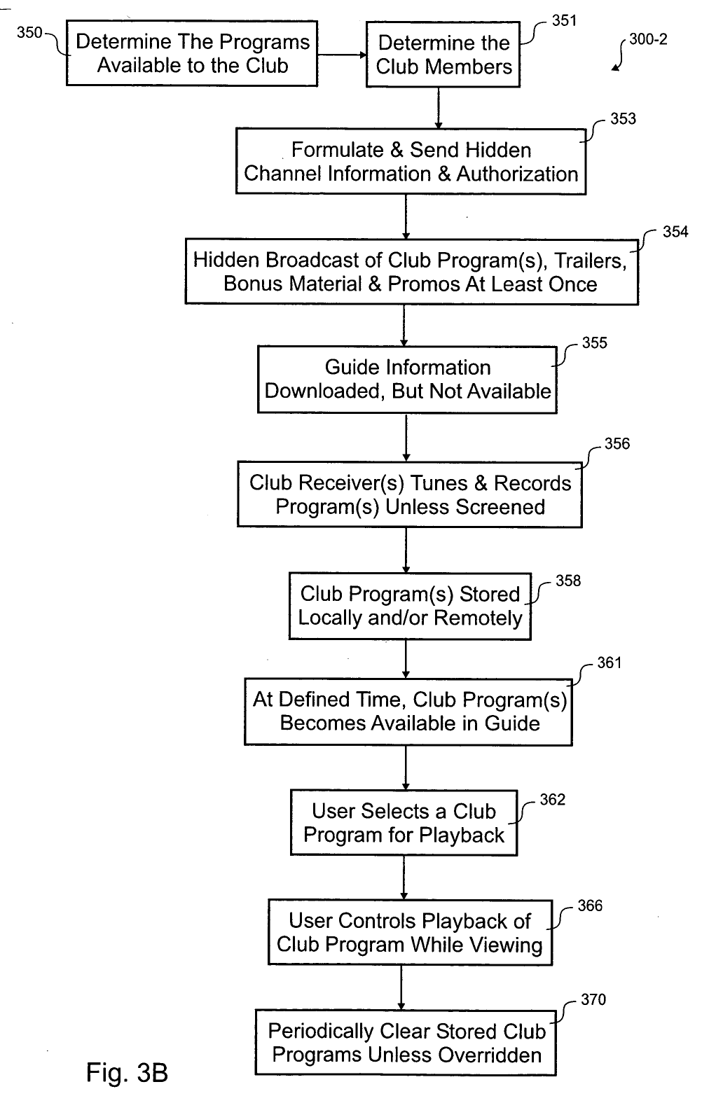

Referring next to FIG. 3A, a flow diagram shows a process for pre-storing a club program at a user location where the club program is transported on a hidden channel. Club programs are programs that are made available to a club member, such as, a user, user location, set top box, or other grouping of users. The club programs are SVOD selections that are available both on demand and from a linear schedule of programs. Some embodiments include programs not necessarily in the linear schedule as club programs. A user may become a club member by subscribing through a menu, mail or a phone call. In some cases, club membership is bundled with basic service or some premium service. Club membership may or may not require any fee. In some cases, all users are club members by default. Some embodiments may store the programs local to the user before the user subscribes to the club such that the programs are immediately available should the user subscribe.

In this embodiment, the user location is subscribed to one or more linear premium channels. A package of club programs is offered with VOD control of playback as a benefit. Those club programs, that may or may not require additional compensation, also are scheduled in the linear schedule of those premium channels. Other embodiments could record programs without being tied to a linear program or could allow recording programs for a fee or some other compensation even if not a subscriber to the premium channel.

The package of club programs has a pre-set composition, for example, twenty of the most popular programs from the linear schedule of a premium channel or group of premium channels. Other embodiments could set the pre-set composition by the number of hours (e.g., five, ten or thirty hours of programming) or tie it to storage size (e.g., thirty gigabytes of the program store 208). In some embodiments, the club programs correspond to a free channel included in a programming subscription where the free channel does not require a separate payment.

The pre-set composition could be based upon a package of similar offerings. For example, these offerings could have a common theme or genre, similar MPAA or content advisory ratings, the same category (e.g., movie, sitcom, comedy, cartoon, etc.), or any other common characteristic. These compositions could have a pre-set number of titles that are filtered or screened by user preferences. It could be that a single title is part of two packages in some embodiments, for example, a new western genre movie may be all of a new release, a comedy and a western and available in those three different pre-set packages.

The pre-set composition could have options that could have different pricing in some embodiments. In one embodiment, the user can have ten programs stored at any given time. Some of those programs may be marked by the user to save. The remainder of the programs not marked would be periodically replaced with new selections. The user could purchase different size packages in some embodiments, for example, five, ten, fifteen, twenty, etc. programs or hours of programming could be stored at any given time. Some embodiments could allow a package size of one program to allow purchase of a single offering in the linear schedule for viewing on demand. One embodiment allows adjusting the churn rate of programs such that programs are replaced at different paces. For example, the user might specify only five new selections should be downloaded per week or month.

The depicted portion of the process begins in step 350 where a linear schedule is analyzed to determine which programs to offer to the club with local playback control. Typically, the desirable programs are offered as club programs, but any scheme could be used. This embodiment transfers the whole club program to the user location, but other embodiments could only pre-store a portion and get the remainder from a NVOD stream or packet network stream after viewing has begun.

The club programs are chosen by someone other than the user in this embodiment, for example, the content provider 130 or multi-system operator (MSO). Some embodiments could allow the user to influence the shows that are included as club programs based upon the information in the preference database 160, while other embodiments could allow the user to select programs from the linear schedule to record. The user could put in parameters to prioritize what is available as a club program from all that are available. For example, there could be a possible fifty offerings, but the user screens or filters by genre, MPAA rating, critical acclaim, release date, actor, director, production company, keyword, or any other characteristic to choose a subset that is recorded. Part of the configuration of the SVOD service could be to get preference information from the user or could rely upon building preferences from the types of shows the user watches.

In step 351, the club members are determined. In this embodiment, club members are subscribers to a linear channel of programming and have further subscribed to get on demand access to the club programs. In some embodiments, the club members may have particular set top boxes 120 capable of offering the on demand club programs. Part of the determination may be to confirm the equipment can support the service.

Hidden channel information is formulated and sent in step 353. The set top boxes 120 or neighborhood nodes are told when and where to get the club programs with capture request information. The capture request information includes channel information, program identifiers (PIDs), authorization information, keys, etc. This capture request information allows the set top boxes 120 or neighborhood nodes to record the club programs. In this embodiment, the hidden channel cannot be viewed by users with properly functioning equipment. Only after storage do the club programs become available for viewing in an on demand format. Some embodiments, may get some club programs on hidden channels, but get other club programs on a viewable channel that may or may not be described in the program guide.

In one embodiment, the hidden channel can be selected by the user. The set top box 120 displays a message or pattern to indicate that the hidden channel is not available. In the background the set top box 120 is storing the club program currently being sent with the hidden channel. Some channels have dead or remnant time where a test pattern might normally be shown. In those time periods, club programs could be sent. Some embodiments send the club programs with terrestrial broadcast transport during dead times in the linear schedule or on unused channels. Other embodiments send clubs programs as opportunistic data that uses unused bandwidth on a particular carrier channel.

In step 354, the club program is broadcast or multicast to a group of set top boxes 120. The broadcast of this embodiment can be done over one or more channels. The broadcast could be part of the linear schedule, at an unannounced time or in a hidden datastream not accessible to the user during download. Typically, a time in the middle of the night or any other time is used for the broadcast or multicast. If the set top box 120 has the capability to tune multiple channels at one time, the speed of download can be increased by downloading a program through multiple channels. Alternatively, the club program could be delivered on a single channel, but use a datarate faster than playback. Any transport could be used for those program downloads, for example, MPEG 2, MPEG 4 or packet switched transport. It is to be further understood that other embodiments could use a broadband WAN or Internet connection to download the club programs.

In addition to club programs, other content could be sent to club members. Some embodiments could send video previews and/or descriptions of upcoming club programs. The user could view the preview or description and prevent storage if uninterested. A subset of programs could be selected such that unselected programs are only stored if room is available. Also, promotional information such as video clips, background music, overlay graphics and text could be downloaded to only club members. Some club programs might have bonus material such as that commonly found on DVD disks (e.g., behind the scenes video, directors cuts, video games, songs, music videos) that could also be stored on club member set tops.

In one embodiment, program information (e.g., box art, trailers, critical ratings, content ratings, and/or program descriptions) are delivered a period of time before the club program is scheduled for sending. The user is given the period of time to inspect the program information. Through the program guide, the user can cause the club program to not be recorded. In an alternative embodiment, the program information is sent before an on demand program is delivered and the user must take a positive step to cause the program to be stored and made available on demand. The user may be charged for each selected program or could be charged for a package of programs.

The club members have the capture request information to allow recording of the club program in step 356. The accounts that are not part of the club would not have the ability to capture the club program in this embodiment. In cases where the set top box 120 does not have the resources to currently record the club program, it can be captured the next time it is broadcast. If the set top box 120 has already recorded a program, future captures of the program are not performed. Any filtering criteria in the preference database 160 could be applied before the program is stored to tailor the service for the user(s). Although this embodiment applies the criteria when the program arrives, other embodiments could selectively send the capture request information to a subset of the club members to selectively enable those users that want to record a particular program.

The club programs are stored local or remote to the user location in step 358. The program store 208, the neighborhood store 148 or headend store 144 could hold the club programs in various embodiments. Some embodiments could store a first portion of the club program and download the remainder from a NVOD or broadband network connection when viewing commences. One embodiment stores a portion of the program in a local program store 208, but requests the remainder from a neighborhood store 148 or headend store 144 once a desire to view the program is detected.

The guide database 164 includes information on the club programs. It could be that the guide database 164 is updated with information on all possible shows in the linear schedule as well as the club programs on a regular basis. This embodiment downloads information from the guide database 164 for the club programs. Alternatively, a basic set of information could be first downloaded to the guide database 164 as part of a regular schedule. An augmented set of information could be later downloaded to the guide database 164 for the club programs that are recorded. Some embodiments download the guide information at the same time as the club program where the guide information could be embedded as metadata. In one embodiment, the capture request information includes guide information and is received in step 353.

One embodiment prevents viewing of a club program until a time set relative to the linear broadcast of that club program. For example, the on demand club program may be downloaded a few days before it is played in the linear schedule. Viewing of the on demand version of the club program may only be possible after the start of the version in the linear schedule. Also, viewing of the on demand version may be prevented at some time relative to the playing in the linear schedule. For example, the on demand version may be automatically erased a week after its last appearance in the linear schedule unless erased earlier by the user or the system to free space for additional offerings. When viewing is not possible of a stored program, the program guide may not include the club program in the listing or separate it in some way. For example, the stored programs could be listed in a different color or in a menu indicating that they will be available soon.

In step 362, the user selects one of the club programs or other stored programs for playback. The program can be selected from a menu or selected while watching a club program that is also being received in real time from the linear schedule. The menu could be could be customized according to the preferences of the user(s). The set top box 120 retrieves the club program from the program store 208 when the club program is selected for playback. Where a program is available on the linear schedule and on demand as a club program a special color, graphic or icon could be used to indicate the dual format to the user.

Stored promotional information could be used by the content provider in conjunction with playback of the club program or in the menus. A promotional video clip could be played before and after the club program. Graphic overlays such as a content provider identifier could be added to the played video. Additional, text messages and barkers could display promotional information.

Playback of the club program can be fully controlled by the user in step 366. For example, the user can command the set top box 120 with the remote control to fast forward, rewind, pause the playback, etc. as can be done with conventional on demand programs. Use of the club program could be limited in various ways during the month to comply with any contractual requirements of the copyright holder, user specified limits on costs, or parental controls, for example. Additionally, the set top box 120 could automatically erase the club program when a window defined for its use by the content provider has expired (or some other condition has triggered) unless the copyright holder allows other storage arrangements, such as, storage for one month, one year or indefinitely. Some embodiments allow the user to intervene and prevent automatic deletion which may or may not incur an additional fee for this service.

When the program store 208 is full or cannot record additional content, older or lower priority recordings could be erased to make room for new items. For example, the program store 208 may have one hundred hours available to record. The storage capacity available for club programs could be limited by user preference to ten hours of programming. After four months, the forty hours would be occupied. New recordings would write over the oldest recordings or least watched programs. Further, a check for duplicates could be performed before recording a club program again.

Referring to FIG. 3B, another process for pre-storing a club program for the user using a hidden channel is shown. This embodiment replaces step 360 with steps 355 and 361. At some point, guide information that references the club programs is downloaded in step 355. The position of step 355 in the flow chart can happen any time before step 361 is performed. This guide information includes descriptions, reviews, availability time, etc. relating to the club program. This guide information could be embedded in the club program as metadata or sent separate from the club program. This guide information does not become visible to the user until step 361 where the downloaded club program is shown in the menu screens. Prior to appearing in the menu, there is no way for the user to select the club program even though it may have been stored and otherwise available for some time. The availability time in the guide information indicates when the club program should become viewable.

A number of variations and modifications of the invention can also be used. For example, there could be a large volume of programs potentially available to club members. The club members could request individual titles and/or specify criteria to choose a small subset of the large volume of programs. The content provider could choose which programs to send based upon the requests of users. For example, a user may specify five specific video programs or three broad categories from a menu on the set top box or a web site where selection of hundreds, thousands or more club videos are possible. The content provider would send the first four within a few weeks because of their popularity with the user base, but the fifth selection may not be sent for a month or two because only a few in the user base want that more obscure selection. In this way, video delivery over a traditional broadcast system can more efficiently meet user demands in one embodiment.

In some embodiments, the large volume of programs need not be limited to those available in the linear schedule. Each selected video could have a expected delivery date which is shown in the menu. As popularity increases, the expected delivery date may get sooner such that desirability feeds back in a loop to increase frequency of delivery. The menu screens could be updated with a different expected delivery date as more requests are made such that the user can receive updates on the expected delivery.

In one embodiment, the club programs can be recorded from the linear schedule. The hidden broadcast of the club program may not have been recorded. For example, the tuner resources could have been busy when the club program was sent on the hidden channel. In those situations, the club program could be recorded from the linear schedule using a viewable channel.

Some of the above embodiments pre-store club programs that track programs in the linear schedule. Other embodiments could offer a VOD service not tied to the linear schedule using similar principals. The VOD programs could be sent with hidden channels. All the VOD selections could be stored in the set top box and made available in the program guide for on demand viewing. The user may or may not have to subscribe to an additional service to get access to the VOD programs. Packages of VOD programs may be made available or the on demand programs may be purchased separately.

While the principles of the invention have been described above in connection with specific apparatuses and methods, it is to be clearly understood that this description is made only by way of example and not as limitation on the scope of the invention.

What is claimed is:

1. A video delivery system for on-demand videos at least partially stored proximate to a user location, the video delivery system comprising:
a plurality of channels that are normally viewable within the user location, wherein a hidden channel of the plurality of channels transports a hidden video stream that cannot be viewed as streamed to the user location; and
a content receiver coupled to the plurality of channels, the content receiver comprising:
a storage device coupled to the hidden channel and proximate to the user location, wherein the storage device stores at least a portion of the hidden video stream in a non-volatile manner, and
a video rendering circuit coupled to the storage device, wherein the video rendering circuit produces a video signal representative of the portion.

2. The video delivery system for on-demand videos at least partially stored proximate to the user location as recited in claim 1, wherein the portion is part of a subscription video service where available videos in the subscription video service are chosen at a point away from the user location.

3. The video delivery system for on-demand videos at least partially stored proximate to the user location as recited in claim 1, wherein a user can filter the available videos to selectively couple the available videos to the storage device.

4. The video delivery system for on-demand videos at least partially stored proximate to the user location as recited in claim 1, wherein the content receiver determines if the content receiver is authorized to record the portion.

5. The video delivery system for on-demand videos at least partially stored proximate to the user location as recited in claim 1, wherein the portion is recorded with the storage device before a request for the portion from the user location.

6. The video delivery system for on-demand videos at least partially stored proximate to the user location as recited in claim 1, wherein the plurality of channels are multicasted to a plurality of content receivers, whereby any of the plurality of content receivers can record the portion.

7. The video delivery system for on-demand videos at least partially stored proximate to the user location as recited in claim 1, wherein the plurality of channels uses transport over at least one of: a coaxial television cable, a satellite television link, an optical fiber television cable, a wireless television link, and terrestrial television broadcast link.

8. The video delivery system for on-demand videos at least partially stored proximate to the user location as recited in claim 1, wherein tuning information is communicated to the content receiver to identify the hidden channel.

9. The video delivery system for on-demand videos at least partially stored proximate to the user location as recited in claim 1, wherein the plurality of channels are transported using at least one of: terrestrial broadcast, cable television and satellite television topologies.

10. A video delivery method for a video broadcast system, the video delivery method comprising steps of:
determining a subset of a plurality of content receivers, wherein the plurality of content receivers are multicast a plurality of video streams that each have an associated channel;
commanding the subset of the plurality of content receivers to tune a hidden channel;
sending a hidden video stream on the hidden channel, whereby the plurality of content receivers not part of the subset cannot tune to the hidden video stream when operating normally; and
commanding the subset to store at least a portion of the hidden video stream in a non-volatile manner.

11. The video delivery method for the video broadcast system as recited in claim 10, wherein the commanding steps are performed with a single command for each of the plurality of content receivers.

12. The video delivery method for the video broadcast system as recited in claim 10, further comprising a step of commanding the subset to delete the portion of the hidden video stream.

13. The video delivery method for the video broadcast system as recited in claim 10, further comprising a step of commanding the subset to delete the portion of the hidden video stream unless a user has manually overridden deletion of the portion.

14. A computer-readable medium having computer-executable instructions for performing the computer-implementable video delivery method for the video broadcast system of claim 10.

15. A video reception method for a video broadcast system, the video reception method comprising steps of:
determining when a hidden video stream will be multicast;
determining a hidden channel for the hidden video stream;
tuning to the hidden channel;
storing at least a portion of the hidden video stream, wherein:
the four preceding steps are performed without interaction with the user, and
the storing step is in a non-volatile manner;
retrieving the portion as requested by the user; and
producing a video signal representative of the portion, whereby the user can view a video picture produced with the video signal.

16. The video reception method for the video broadcast system as recited in claim 15, wherein the first-listed four steps are only performed by authorized content receivers.

17. The video reception method for the video broadcast system as recited in claim 15, further comprising a step of receiving an authorization message allowing storage of the portion.

18. The video reception method for the video broadcast system as recited in claim 15, further comprising a step of receiving tuning information allowing identification of the hidden channel and the hidden video stream.

19. The video reception method for the video broadcast system as recited in claim 15, wherein the hidden video stream is not normally viewable in properly functioning content receivers.

20. The video reception method for the video broadcast system as recited in claim 15, further comprising a step of authorizing the tuning step before allowing performance of the tuning step.

21. A computer-readable medium having computer-executable instructions for performing the computer-implementable video reception method for the video broadcast system of claim 15.
